(19) United States
(12) Patent Application Publication
(10) Pub. No.: US 2019/0016576 A1
(43) Pub. Date: Jan. 17, 2019

(54) Bottle openers and related methods

(71) Applicant: Bottle Breacher, LLC, La Jolla, CA (US)

(72) Inventor: Elijah Crane, Tucson, AZ (US)

(21) Appl. No.: 15/668,640

(22) Filed: Aug. 3, 2017

Related U.S. Application Data
(63) Continuation-in-part of application No. 29/610,466, filed on Jul. 12, 2017, now Pat. No. D824230.
Application No. 29/610,466 is a continuation-in-part of application No. 29/610,477, filed on Jul. 12, 2017.
Application No. 29/610,477 is a division of application No. 29/610,466, filed on Jul. 12, 2017, now Pat. No. D824230.

(51) Int. Cl. B67B 7/16

(52) U.S. Cl. CPC B67B 7/16

(57) ABSTRACT

Disclosed is a spherical bottle opener and methods of using the same.

### CROSS-REFERENCE TO RELATED APPLICATIONS

This document is a continuation in part of U.S. Des. Pat. Ser. No. 29/610,466 (filed Jul. 12, 2017) entitled Bottle Opener. That document is incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of bottle opening apparatus.

### Background of the Invention

Bottle openers can come in a variety of shapes and sizes and are used for the removal of bottle caps from bottles. Typically, a bottle opener utilizes a lever, wherein the load is inserted under the lip of a bottle cap so a fulcrum is placed over the top of a bottle cap. When the user applies an upward effort on the lever, the load will pull the bottle cap up so that it pivots around the fulcrum to open the bottle.

In a variety of settings and environments, users want to be able to open a bottle with ease, efficiency, and a comfortable grip. Part of the efficiency of a bottle opener depends on size, shape, and weight of the apparatus. Moreover, some users prefer a certain aesthetic for bottle openers to help display their personality, allegiances, or style.

### SUMMARY OF THE INVENTION

In view of the foregoing, an object of this disclosure is to provide a bottle opener in the form of a sphere and methods of using the same.

It is another object of this disclosure to provide a bottle opener that is easy to use, efficient, and comfortable to grip.

It is yet another object of the present application to provide a bottle opener that when held give the appearance of a ball, but has the capability to split apart and use one of the hemispheres to open bottles.

In other circumstances, another objective of the present application is to provide consumers a bottle opener that can regain its original ball shape composure at any time.

It is yet still another objective of the present application to provide consumers a bottle opener that will not easily split apart once it gains its spherical shape. The disclosed embodiment requires a significant amount of force to the device split into the two hemispheres.

In one preferred embodiment, disclosed is a bottle opener comprising a base with a hemispherical shell and a vented face plate with a magnet on a riser and at least one tenon; and a grip with a hemispherical shell and a lever face plate with a lever lip and at least one mortise; wherein the mortise and tenon are configured to mate such that the magnet of the base and the lever face plate magnetically interface such that the hemispherical shells of the base and grip form a sphere.

Other objectives of this invention will become apparent to those skilled in the art once the invention has been shown and described. These objectives should not be construed as limitations of the applicant's invention. Rather, they are suggestions of the many benefits that may be realized by the apparatus in its current application, as well as its many embodiments.

In one mode of use, the bottle opener may be obtained with the grip and base coupled as a sphere. Preferably, the sphere may be divided into the base and grip via both (a) breaking the magnetized interface of the magnet and face plate and (b) uncoupling the mortise and tenon. Finally, a bottle may be provided to the lever face plate such that the load lip is inserted under the lip of a bottle cap so a fulcrum defined by the lever face plate is oriented over the top of a bottle cap. When the user applies an upward effort on the lever plate, the load lip will pull the bottle cap up so that it pivots around the fulcrum to open the bottle.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective drawing of the invention when both hemispheres are interlocked together forming a sphere; and,

FIG. 2 is a perspective drawing of the invention when the hemispheres are detached from one another.

In the figures, the following components are represented by the associated reference numerals:
Bottle opener —100
base—110
base face plate —111
magnet —112
tenon —113
hole —114
base hemispherical shell —115
riser—116
grip —120
lever face place —121
load lip—122
mortise —123
grip hemispherical shell—125

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

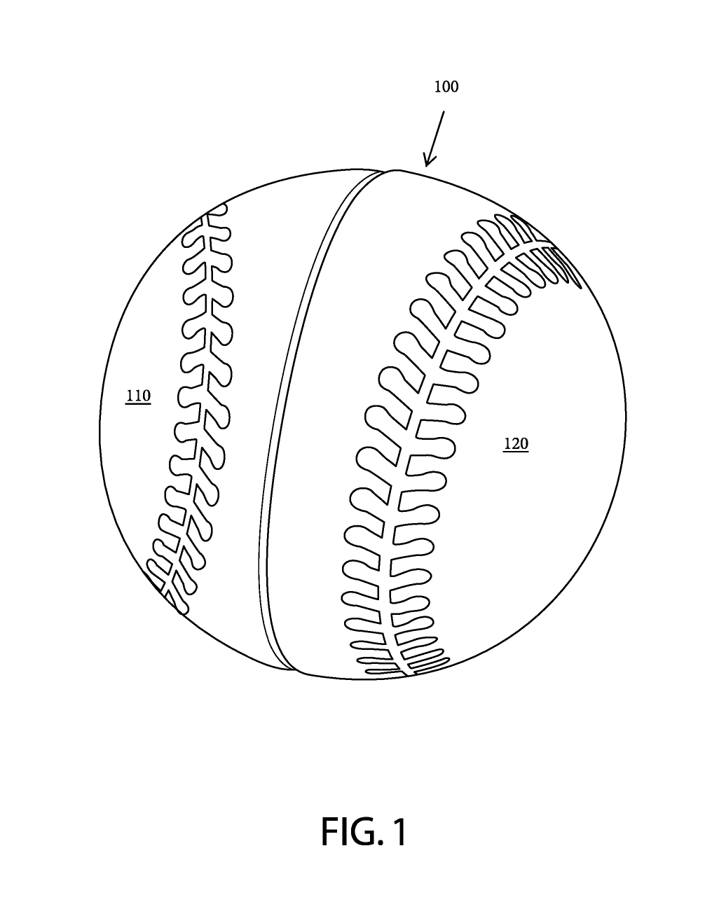

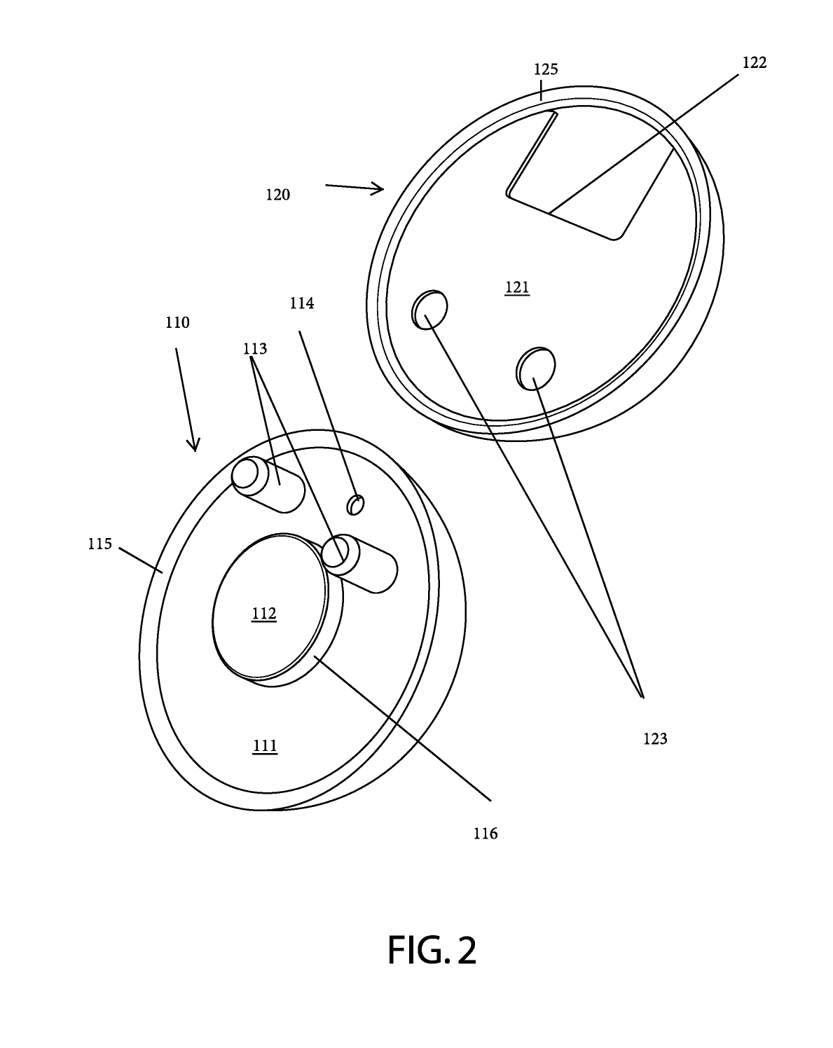

FIG. 1 is a perspective view of the sphere bottle opener 100. FIG. 2 is an exploded or opened view of the bottle opener 100 of FIG. 1. As shown, the bottle opener 100 preferably comprises a base 110 with a hemispherical shell 115 and a hole-punched (114) face plate 111. As shown, the face plate 111 features a hole 114 through the faceplate 111, two tenons comprising by cylindrical projections, and a riser 116 with a magnet disposed thereon (or that may alternatively be a magnetized appendage). Still referring to FIGS. 1 and 2, the bottle opener also comprises a grip 120 with a hemispherical shell 125 and a lever face plate 121 with a lever lip 122 and two mortises 123.

Yet still referring to FIGS. 1 and 2, the mortises 123 and tenons 113 are configured to mate such that the magnet 112 of the base and the lever face plate 121 magnetically interface. Suitably, the upper portion of the tenons 113 are beveled or otherwise tapered so that insertion of the tenons 113 into the corresponding mortises 123 is simplified. In one embodiment, when the mortise and tenons are mated, the hemispherical shells 115, 125 of the base 110 and grip 120 form a sphere as shown in FIG. 1.

Referring now to FIG. 2 alone, the lever lip 122 of the lever face plate 121 suitably features adequate dimensions so that it accommodates a typical bottle cap on a bottle. In one embodiment a preferable length for the lip 122 is 0.5-1.0 inches in length. In a preferred embodiment the gap between the first and second ends of the opening 15 is 0.625 inches.

Referring back to FIG. 1, a perspective view of one embodiment of the bottle opener 100 is shown, wherein the spherical bottle opener 1000 represents a baseball. Preferably, the sphere bottle opener can be designed to depict a multitude of spherical items, such as, a golf ball, a soccer ball, a bowling ball, an 8-ball, or any other spherical shaped items. In an alternative embodiment, an oblong shape or American football is used.

In one embodiment the sphere bottle opener may be comprised of a rigid plastic or a metal, however, the lip 122, is preferably constructed of a metal. In one embodiment, the lip 122 may be a different configuration than shown. For example, the lip 122 may define a tapering crescent or be concaved in relation to the bottom of the sphere bottle opener.

In one mode of use, the bottle opener 100 may be obtained with the grip 120 and base 110 coupled as a sphere (FIG. 1). Preferably, the bottle opener 100 may be divided into the base 110 and grip 120 via both (a) breaking the magnetized interface of the magnet 112 and face plate 121 and (b) uncoupling the mortise 123 and tenon 113. Finally, the a bottle (not shown) may be provided to the lever face plate 121 such that the load lip 122 is inserted under the lip of a bottle cap (not shown) so a fulcrum defined by the lever face plate 121 is oriented relative to the top of a bottle cap (not shown). When the user (not shown) applies an upward effort on the lever plate 121, the load lip 122 can suitably pull the bottle cap (not shown) relative to the bottle (not shown) so that the cap (not shown) pivots around the fulcrum to open the bottle (not shown). For bottle opening purposes, the grip 120 features the lever face plate 121 with the lever lip 122. This lever lip 122 cut out in the face plate 121 allows a bottle cap (not shown) to enter at an approximately 45-degree angle.

Manufacturing Process:

As alluded to above, a preferred shape of the disclosed bottle opener 100 is that of a sphere. FIGS. 1 and 2 show the embodiment constructed of a base 110 and grip 120 defined by metallic hemispherical shells 1 that are mated as one to form the sphere shown. In one circumstance, creating the bottle opener 100 shown in FIG. 1 requires two metal hollowed out hemispherical shells 125, 115 and two circular metal sheets (not shown) for constructing the face plates 111, 121. Suitably, one of the circular sheets (not shown) can be modified with a large and somewhat rectangular carveout to form the lip 122. In addition, the sheet for constructing the face plate 121 can be further modified to have two (2) mortise holes. The other of the circular sheets (not shown), in one embodiment can be provided with a magnet 112 that is positioned on a riser 116 to form the face plate 111 in the base 110. In one mode of construction, the magnet 112 can be epoxied or otherwise affixed to the sheet 111 at a central location and two tenon 113 joints may also be provided. Further, the face plate 111 can be modified to also include a hole 114, which is typically used for hanging during painting.

Once constructed as described above, the faceplates 111 and 121 may suitably be welded, via a blowtorch or other welding device, to the interior portion of the respective shells 115, 125 to create the base 110 and grip 120. For adjusting the aesthetics of the outwear portions of the shells 115, 125 the base 110 and grip 120 may be hung via hook through one of the mortises 123 and the hole 114 for spraying with a powder coat. Once the spray (plastic or paint) is dry, the shells 115, 125 may be painted with several layers of paint to give a clear even white coat and a baseball aesthetic. In one embodiment, the shells 115, 125 may be joined together and positioned to undergo laser engagement to yield hemispheres that possess the iconic red stitching pattern of the traditional baseball.

Applications:

The disclosed bottle opener is intended to closely resemble an actual baseball (or other ball) in size and weight. The diameter of the closed bottle opener 100 (see FIG. 1) is in the range of 3 to 10 inches, which allows a consumer to conformably hold the bottle opener 100 with one hand without undue pressure. Once the bottle opener 100 is split apart (see FIG. 2), the base 110 and grip 120 are approximately symmetrical halves consisting of different components on their face plates 111, 121.

FIG. 2 illustrates the bottle opener 100 with the base 110 and grip 120 split apart. The base 110 contains an epoxied magnet 112 which is configured to magnetically interface with the base plate 121 of the grip 120 so that the shells 115, 125 of base 110 and grip 120 can stay closed as a sphere until an outside force stronger than the magnetic force is applied to separate the base 110 and grip 120 as shown in FIG. 2. The magnet 112 is suitably attracted through magnetic forces to the metal composition of the faceplate 121. The magnet 112 is preferably powerful enough to the keep the bottle opener 100 together as shown in FIG. 1 without any external pressure such that the bottle opener 100 may keep its spherical shape when thrown into the air by a user.

Aside from the magnetic forces described above, the bottle opener 100 may be further stabilized by a mortise 123 and tenon 113 mechanism. The mortise 123 and tenon 113 mechanism allows the bottle opener 100 to keep stay connected in a spherical shape (see FIG. 1) when centrifugal force is applied to the shells 115, 125. The combination of this mortise 123 and tenon 113 mechanism and magnet 112 also allows the bottle opener 100 to keeps its composure when tossed or rolled. In other words, once the tenons slide into the mortise holes, the two hemispheres resist movement in any direction unless opposing external forces are applied to separate the hemispheres from one another. This mechanism also prevents the two hemispheres from being split apart by applying opposing sliding them away from one another in opposing directions.

As disclosed above, the depicted mortise 123, tenon 113, and magnet 112 operate to retain connection of the bottle opener 100 components in a spherical shape (FIG. 1). It should be noted that that configurations and locations of the mortise 123, tenon 113, and magnet 112 are only representative of a preferred embodiment. In other embodiments, the mortise 123, tenon 113, and magnet 112 can be swapped between the base 110 and grip 120 or oriented differently relative to the face plates 111,121. The assembly of these items relative to each other can be accomplished in any configuration or position so long as their positioning and configuration do not conflict with operation of the load lip 122. Ultimately, the positioning and configuration should preferably accomplish a magnetized and interlocking releasable connection between the base 110 and grip 120 during periods of non-use of the load lip 122. The magnet 112 may also admit to varying polygonal shapes. Those of skill in the art will appreciate acceptable configurations and placement locations of the coupling parts to accomplish the spirit and intent of the disclosed invention after reading this specification.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A bottle opener comprising:
two hemispheres that can removably mate with each other to form a sphere;
wherein at least one of the hemispheres features a lever lip on an inside surface for opening a bottle when the two hemispheres are not mated.

2. The bottle opener of claim 1 wherein said two hemispheres may be mated via use of at least one mortise and corresponding tenon combination.

3. The bottle opener of claim 2 wherein said two hemispheres may further be mated via use of at least one magnet.

4. The bottle opener of claim 1 wherein said two hemispheres may be mated via use of a magnet.

5. The bottle opener of claim 4 wherein said two hemispheres may further be mated via use of at least mortise and tenon combination.

6. The bottle opener of claim 1 further comprising:
Wherein one of the hemispheres is a base defining a hemispherical shell comprising a face plate with a magnet and at least one tenon fixedly disposed thereon; and
Wherein another one of the hemispheres is a grip defining a hemispherical shell comprising a lever face plate defining said inside surface with the lever lip and said lever face plate featuring at least one mortise disposed therein;
wherein the mortise and tenon(s) are configured to mate such that the magnet of the base and the lever face plate magnetically interface and such that the hemispherical shells of the base and grip form a sphere.

7. The bottle opener of claim 6 wherein said sphere has the appearance of any of the group consisting essentially of either baseball, soccer ball, tennis ball, golf ball, eight-ball, pool ball, or gear shift ball.

8. A method of opening a bottle comprising:
obtaining a bottle opener comprising
two hemispheres that can removably mate with each other to form a sphere and,
wherein at least one of the hemispheres features a lever lip on an inside surface for opening a bottle when the two hemispheres are not mated;
dividing the bottle opening into the two hemispheres;
providing a bottle cap on a bottle to the lever lip; and,
applying an effort to pull the bottle cap off of the bottle.

9. The method of opening a bottle of claim 8 further comprising:
wherein a first one of the hemispheres is a base with a hemispherical shell and a face plate with a magnet and at least one tenon;
wherein a second one of the hemispheres is a grip with a hemispherical shell and a lever face plate with a lever lip and at least one mortise;
wherein the mortise and tenon are mated such that the magnet of the base and the lever face plate magnetically interface and such that the hemispherical shells of the base and grip form the sphere;
dividing the sphere into the base and grip via both (a) breaking the magnetized interface of the magnet and face plate and (b) uncoupling the mortise and tenon;
wherein the effort is applied on the lever plate to pull the bottle cap off of the bottle.

10. A method of fabricating a bottle opener in the shape of a ball, the method comprising the steps of:
obtaining a grip hemispherical shell and a base hemispherical shell;
obtaining two circular sheets;
modifying a first one of the circular sheets with carveout to form a lip so that the first one of the circular sheets becomes a face plate for the grip hemispherical shell;
disposing the faceplate for the grip hemispherical shell in the grip hemispherical shell;
mechanically coupling a magnet to a second one the circular sheets to form a face plate for the base hemispherical shell;
disposing the faceplate for the base hemispherical shell in the grip hemispherical shell; and,
removably coupling the grip hemispherical shell and the base hemispherical shell to form a sphere by magnetically interfacing the magnet with the face plate for the grip hemispherical shell.

11. The method of claim 3 further comprising the step of modifying the first one of the circular sheets to have at least one mortise hole.

12. The method of claim 4 further comprising the step of modifying the second one of the circular sheets to have at least one tenon disposed thereon.

13. The method of claim 5 wherein the step of removably coupling the grip hemispherical shell and the base hemispherical shell to form a sphere is accomplished by further introducing the at least one mortise to the at least one tenon.

14. The method of claim 3 wherein the magnet is disposed on a riser that is coupled to the second one of said two circular metal sheets.

15. The method of claim 3 wherein the faceplates are welded to the interior portion of the respective grip or base hemispherical shells.

16. The method of claim 3 further comprising the steps of:
modifying the second one of said circular sheets with a hole;
hanging the assembled faceplate for the base hemispherical shell and the base hemispherical shell;
spraying the assembled faceplate for the base hemispherical shell and the base hemispherical shell with a powder coat; and,
painting the powder coat of the base hemispherical shell so that the same looks like one hemisphere of a sports ball.
